(19) United States
(12) Patent Application Publication
(10) Pub. No.: US 2021/0326716 A1
(43) Pub. Date: Oct. 21, 2021

(54) TARGETED PROBING OF MEMORY NETWORKS FOR KNOWLEDGE BASE CONSTRUCTION

(71) Applicant: Elsevier Inc., New York, NY (US)

(72) Inventors: Ronald E. Daniel, JR., Concord, CA (US); Paul Thomas Groth, Amsterdam (NL); Sujit Pal, Antioch, CA (US)

(73) Assignee: Elsevier Inc., New York, NY (US)

(21) Appl. No.: 17/230,594

(22) Filed: Apr. 14, 2021

Related U.S. Application Data
(60) Provisional application No. 63/010,359, filed on Apr. 15, 2020.

(51) Int. Cl. G06N 5/02; G06N 5/04

(52) U.S. Cl. CPC G06N 5/022; G06N 5/04

(57) ABSTRACT

A system to maintain a knowledge base including a device to: (i) generate a first interface to: receive a query for transmission to a question-answer system and provide a response including one or more proposed triple in a list, (ii) after selection of a particular triple, generate a second interface to: provide at least one evidence record including a span of text in support of the particular triple, and provide one or more control element associated with each evidence record including at least one of: a first control element selectable to cite its corresponding evidence record and span of text as supporting the particular triple, or a second control element selectable to prevent its corresponding evidence record and span of text from being cited as supporting the particular triple, and (iii) generate a data structure, based on selections of the one or more control element, to update the knowledge base.

### CROSS REFERENCE TO RELATED APPLICATIONS

The present application claims priority to U.S. Patent App. No. 63/010359 filed on Apr. 15, 2020, the contents of which are hereby incorporated herein in its entirety.

### TECHNICAL FIELD

### Background

The present disclosure generally relates to systems and/or methods for constructing and/or maintaining a knowledge base, and more specifically, to constructing and/or maintaining a knowledge base using an editorial device.

A conventional computer includes a processor that may access a memory to execute program instructions stored in the memory. The processor may execute the program instructions and use data stored in the memory as input to compute a resulting output. A neural network, on the other hand, includes a plurality of interconnected processor nodes that operate in parallel and are organized in layers (e.g., an input layer, one or more than one hidden layer, and an output layer). The input of each layer is the output of one or more previous layers (e.g., an input layer to a first hidden layer, to a second hidden layer, to an output layer, and/or the like). In general, each processor node is connected to some or all of the other nodes with a weighted connection. The level of output from a connected processor, multiplied by the weight of the connection from that processor to a second, forms part of the input signal to the second processor. The total input signal to the second processor is the sum of the weighted outputs of the processors connect to the input.

These weights are updated according to various types of learning rules. For example, the most common learning rule requires that the output the network is to learn for each of several inputs is known. The network is trained by applying an input, computing the final output, comparing that to the desired output, then changing the weights to slightly reduce the difference (error) between the actual and desired outputs. This repeats many times until the difference between the actual and desired output, over all of the input and output patterns being used, is minimized.

A neural network is generally adaptive since, during training, it modifies itself with each new data set processed. Accordingly, each new data set received as input at the input layer allows the network to assess its accuracy and update its weights to learn how to process that kind of input. Accordingly, systems and methods are desirable for selecting relevant data sets (e.g., authoritative, valid, high quality, and/or the like) to be received as input at the input layer.

In general, a neural network is designed to identify patterns from input data, to classify data, to cluster data, and/or to make a prediction based on data. Accordingly, a neural network may be used to obtain information regarding unstructured text (e.g., text which lacks metadata, text not easily mapped to a database field, text provided in natural language, and/or the like). A neural network may be initially trained using input data and known outputs. When training, connectors that contribute to a correct known output may be weighted more heavily while those connectors failing to contribute to the correct known output have their weight reduced. After training, the weights are fixed, and the neural network is able to receive a query (e.g., a natural language query and/or the like) and return a response based on data that has been fed into the neural network.

Conventionally, a knowledge base has been “edited” from the front end. For example, a person (e.g., editor, subject matter or domain expert, trained specialist, and/or the like) would manually research material (e.g., books, scientific articles, journals, and/or the like) on a topic of interest, read found materials, and fill out and submit a form to have any relevant information to the knowledge base. Unfortunately, such an approach is time consuming, relies on that person's research ability (e.g., to find material relevant to the topic of interest) as well as that person's ability to fully evaluate (e.g., possibly hundreds of pages) each found material (e.g., as relevant to the topic of interest) and then summarize all of that into changes or additions to the information in the knowledge base. Accordingly, systems and/or methods are desirable for not only a more efficient front end system (e.g., for generating selective input data sets) but also a back end system for curating neural network outputs to construct and/or maintain a knowledge base associated with the neural network.

### SUMMARY

In one embodiment, a system to maintain a knowledge base includes a device having a processor and a memory, the memory storing program instructions that, when executed by the processor, cause the device to: generate a first interface, wherein the first interface is configured to: receive a query for transmission to a question-answer system, and provide a response to the query from the question-answer system, wherein the response includes one or more than one proposed triple in a list of proposed triples. The program instructions, when executed by the processor, further cause the device to: after selection of a particular triple in the list of proposed triples, generate a second interface, wherein the second interface is configured to: provide at least one evidence record associated with the particular triple, wherein each evidence record includes a span of text in support of the particular triple, and provide one or more than one control element in association with each evidence record, wherein the one or more than one control element includes at least one of: a first control element selectable to cite its corresponding evidence record and span of text as supporting the particular triple, or a second control element selectable to prevent its corresponding evidence record and span of text from being cited as supporting the particular triple. The program instructions, when executed by the processor, yet further cause the device to: generate a data structure, based on selections of the one or more than one control element, to update the knowledge base.

In another embodiment, a system to maintain a knowledge base includes a question-answer system having a neural network, a knowledge base, a proposed triples database, a processor, and a memory, the memory storing program instructions that, when executed by the processor, cause the question-answer system to: read a plurality of texts received from an editorial device as input to the neural network, store neural network outputs, corresponding to the plurality of texts, as proposed triples in the proposed triples database, respond to queries received from the editorial device based on the proposed triples stored in the proposed triples database, and update the knowledge base based on one or more than one data structure received from the editorial device.

In yet another embodiment, method to maintain a knowledge base, includes: entering, via a first interface of an editorial device, a query for transmission to a question-answer system, receiving, via the first interface, a response to the query from the question-answer system, wherein the response includes one or more than one proposed triple in a list of proposed triples, receiving, via a second interface of the editorial device, at least one evidence record associated with a particular triple selected from the list of proposed triples, wherein each evidence record includes a span of text in support of the particular triple, selecting, via the second interface, a control element associated with each evidence record, wherein the control element includes one of: a first control element to cite the corresponding evidence record and span of text as supporting the particular triple, or a second control element to prevent the corresponding evidence record and span of text from being cited as supporting the particular triple, and generating a data structure, based on the selected control element, to update the knowledge base.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 depicts a block diagram of an illustrative system, according to one or more embodiments shown or described herein;

FIG. 2 depicts a illustrative interface of an editorial device of the system of FIG. 1, according to one or more embodiments shown or described herein;

FIG. 3 depicts another illustrative interface of the editorial device of the system of FIG. 1, according to one or more embodiments shown or described herein;

FIG. 4 depicts yet another illustrative interface of the editorial device of the system of FIG. 1, according to one or more embodiments shown or described herein;

FIG. 5 depicts a horizontally scrolled view of the illustrative interface of FIG. 4, according to one or more embodiments shown or described herein;

FIG. 6 depicts a flow diagram of an illustrative method for the construction of a knowledge base using a neural network, according to one or more embodiments shown or described herein; and

FIG. 7 depicts a flow diagram of an illustrative method for using the knowledge base, constructed and/or maintained using the neural network, according to one or more embodiments of the present disclosure.

### DETAILED DESCRIPTION

Various embodiments of the present disclosure relate to computer-based systems and methods for the generation and/or maintenance of a knowledge base using a neural network. According to various aspects, the knowledge base may be generated and/or maintained via targeted querying of the neural network that has been inputted with text. Maintaining the knowledge base, via the systems and/or methods described herein, improves the coverage, timeliness, and accuracy of the knowledge base.

Various embodiments described herein provide systems and methods for a user (e.g., an editor, a subject matter or domain expert, a trained specialist, and/or the like) to not only evaluate existing assertions of a particular knowledge base but also to administratively control the growth of assertions within that particular knowledge base.

In one example, when a knowledge base query results in no assertions and/or existing assertions that are questionably accurate, the editorial device described herein enables the user to efficiently locate texts (e.g., relevant texts, texts of relatively high evidentiary value, and/or the like) corresponding to that query for input to the neural network. Furthermore, the editorial device and the various interfaces described herein enable the user to efficiently review each assertion (e.g., corresponding to inputted texts) output by the neural network prior to its addition to the knowledge base. More specifically, the editorial device and the various interfaces described herein enable the user to evaluate supporting evidentiary text associated with each assertion and to either approve or disapprove each assertion for addition to the knowledge base.

In another example, when a knowledge base query results in narrow and/or limited assertions, the editorial device described herein enables the user to expand existing assertions. More specifically, the editorial device and the various interfaces described herein enable the user to query the knowledge base with targeted questions and/or enhanced questions to expand assertions associated with that query.

Various embodiments may be described herein with reference to flowchart illustrations of methods, apparatus (systems), and computer program products. Each block of the flowchart illustrations, and combinations of blocks in the flowchart illustrations, may be implemented via executable computer program instructions. These computer program instructions may be provided to a processor of a computer or other programmable data processing apparatus to produce a special purpose machine, such that the instructions, which execute via the processor of the computer or other programmable data processing apparatus, create a system for implementing the functions specified in a flowchart block and/or various combinations of blocks.

The computer program instructions may also be stored in a non-transitory computer-readable memory that can direct or cause the computer or other programmable data processing apparatus to function in a particular manner. In such aspects, the computer program instructions stored in the non-transitory computer-readable memory may define a computer program product (e.g., a manufacture). The computer program instructions of the computer program product, when executed by a processor of the computer or the other programmable data processing apparatus, may implement the functions specified in a block of the flowchart illustrations and/or various combinations of blocks in the flowchart illustrations described herein.

The computer program instructions may also be loaded onto the computer or other programmable data processing apparatus to cause a series of operational steps to be performed on the computer or other programmable apparatus to produce a computer-implemented process such that the computer program instructions which execute on the computer or other programmable apparatus provide steps for implementing the functions specified in a block of the flowchart illustrations and/or various combinations of blocks in the flowchart illustrations described herein.

Various embodiments described herein may include a computer (e.g., server) specially configured or configured as a computer with the requisite hardware, software, and/or firmware. The computer may include a processor, input/output hardware, network interface hardware, a data storage component, and a memory component configured as volatile or non-volatile memory including RAM (e.g., SRAM, DRAM, and/or other types of random access memory), flash memory, registers, compact discs (CDs), digital versatile discs (DVD), and/or other types of storage components. In line with above, the memory component may also include operating logic that, when executed, facilitates the operations described herein. The processor may include any processing component configured to receive and execute instructions (such as from the data storage component and/or memory component). The network interface hardware may include any wired/wireless hardware generally known to those of skill in the art for communicating with other networks and/or devices.

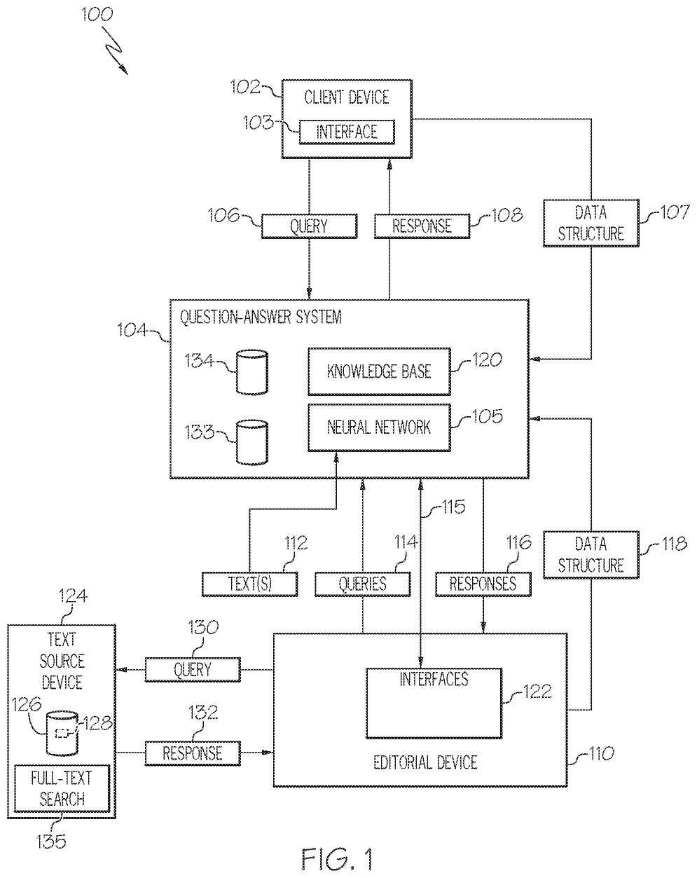

FIG. 1 depicts a block diagram of an illustrative system 100 according to one or more embodiments of the present disclosure. The system 100 may include a client device 102, a question-answer system 104, an editorial device 110, and a text source device 124. Each of the client device 102, the question-answer system 104, the editorial device 110, and the text source device 124 may include a computer or other programmable data processing apparatus as described herein (e.g., specially configured, having a processor executing computer program instructions, and/or the like). Furthermore, each of the client device 102, the question-answer system 104, the editorial device 110, and the text source device 124 may be communicatively coupled, via one or more than one network, such that the communications as described herein occur over the one or more than one network. The one or more than one network may include without limitation a wide area network (WAN), such as the Internet, a local area network (LAN) such as an Ethernet, a mobile communications network, a public service telephone network (PSTN), a personal area network (PAN), a metropolitan area network (MAN), a virtual private network (VPN), and/or another network. Accordingly, each of the client device 102, the question-answer system 104, the editorial device 110, and the text source device 124 may be positioned remotely or locally. In one example, the question-answer system 104 and the editorial device 110 may be positioned locally while the client device 102 and the text source device 124 may be positioned remotely. In another example, the question-answer system 104, the editorial device 110, and the text source device 124 may be positioned locally while the client device 102 may be positioned remotely. Although the editorial device 110 is shown in FIG. 1 as a single device, it should be appreciated that a plurality of editorial devices may each function in a manner similar to the editorial device 110 as described herein. For example, the plurality of editorial devices may be configured as an editorial workflow system that arranges work, as described herein, among multiple users (e.g., editors, reviewers, subject matter or domain experts, trained specialists, and/or the like) and/or their supervisors. Similarly, the client device 102 may include a plurality of client devices that each function in a manner similar to the client device 102 as described herein.

In view of FIG. 1, the question-answer system 104 may be configured to receive a query 106 via an interface 103 of the client device 102. The question-answer system 104 may be configured to transmit a response 108 based on the current state of a knowledge base 120 back to the client device 102 for display on the interface 103. Based on each response 108, the client device 102 may be configured to generate and to transmit a data structure 107 to the question-answer system 104 to build and/or update the knowledge base 120, as described herein. According to aspects described herein, the question-answer system 104 may include a neural network 105. According to various aspects, the neural network 105 may include a memory network (e.g., a machine comprehension network, a reading comprehension network, and/or the like). In some aspects, the neural network 105 and the knowledge base 120 may be separate components selectively loadable (e.g., from respective files stored internal to or external to the question-answer system 104) within the question-answer system 104 (e.g., such that the system 100 is able to load, edit, and save a plurality of knowledge bases). In such aspects, each knowledge base 120 may be loaded into a database management system (e.g., of the question-answer system 104) configured to edit each knowledge base 120. According to some aspects, various neural networks 105, choices of text from the text source device 124, and knowledge bases 120 may complement one another such that they are commonly loaded together. A knowledge base 120 is a technology configured to store complex structured and unstructured information. According to aspects described herein, the neural network 105 may be a Bi-Directional Attention Flow (BiDAF) network. One example BiDAF network is described in a document entitled “BI-DIRECTIONAL ATTENTION FLOW FOR MACHINE COMPREHENSION” to Seo, Minjoon et al., the entire disclosure of which is hereby incorporated by reference herein.

Referring again to FIG. 1, the editorial device 110 may be configured to read a plurality of texts 112 as input to the neural network 105 of the question-answer system 104. According to some aspects, the plurality of texts 112 may include a plurality of pre-selected texts (e.g., full-text book(s), specific chapter(s) of book(s), full-text journal(s), specific paragraphs of journal(s), and/or the like). Here, reading in pre-selected texts may enable the neural network 105 to focus on relevant material, and the inclusion of such relevant materials may reduce the possibility of any false positives. In such aspects, material may be included in or excluded from the pre-selected texts based on pre-defined selection criteria applied by the editorial device 110. Example selection criteria may include selecting texts recognized in a field as authoritative, texts verified as peer-reviewed, and/or the like. Such an approach may be beneficial if the neural network 105 has a limited size. Yet further in such aspects, the editorial device 110 may apply pre-defined data cleaning techniques to the plurality of texts 112 before reading the plurality of texts 112 into the neural network 105. One example data cleaning technique may include accessing a dictionary to correct inaccurate or incomplete data. According to other aspects, the editorial device 110 may apply pre-defined data cleaning techniques to the plurality of texts 112 after reading the plurality of texts 112 into the neural network 105. As one example, the editorial device 110 may evaluate a frequency of one or more than one received response to assess whether noise exists in responses based on the plurality of texts 112. As another example, the editorial device 110 may apply at least one validation rule to one or more than one received response to verify that correct types of responses are being received based on the plurality of texts 112 (e.g., for a subject, a predicate, and/or an object of a triple, as described herein). According to various embodiments, the plurality of texts 112, or at least one portion thereof, may be stored in the knowledge base 120 in a non-textual way. According to various aspects, an output of the question-answer system 104 that results from the reading of the plurality of texts 112 into the neural network 105 and the receiving of a query 106 is a plurality of proposed triples, as described more fully herein.

According to other aspects, the plurality of texts 112 may not include pre-selected texts. In such aspects, the text source device 124 may include a database 126 that stores a body of texts 128 (e.g., health related full-text books, authoritative health related full-text journals, and/or the like). In some aspects, the body of texts 128 may be massive (e.g., capable of being searched via state-of-the-art full-text search engines). In some aspects, the body of texts 128, including each full-text and/or respective portions thereof (e.g., chapters, paragraphs, and/or the like) may be indexed. In such aspects, a full-text search engine 135 may implement search engine index technology (e.g., a relevance mechanism including a BM-25 relevance function, TD-IDF, and/or the like) for the editorial device 110 to retrieve the plurality of texts 112 to read as input to the neural network 105 of the question-answer system 104. For example, the editorial device 110 may be configured to send a text query 130 (e.g., find “X” paragraphs relevant to “endocrine system”) to the full-text search engine 135 within the text source device 124 and to receive a text response 132 (e.g., including “X” paragraphs relevant to “endocrine system”) from the text source device 124. As another example, the editorial device 110 may be configured to send a text query 130 to the text source device 124 and to receive a text response 132 from the text source device 124 including a predetermined number of results (e.g., top 100 results). In such an aspect, the editorial device 110 may read the texts of the text response 132 as input to the neural network 105 as the plurality of texts 112. According to various aspects, an output that results from the reading of the texts of the text response 132 into the neural network 105 is natural language text that provides evidence for a plurality of proposed triples, as described more fully herein.

In view of FIG. 1, the editorial device 110 may be further configured to transmit a plurality of queries 114 to the question-answer system 104. According to various aspects, the plurality of queries 114 may include targeted queries and/or enhanced queries, as described more fully herein. Each query of the plurality of queries 114 may be in plain language form (e.g., no special query language syntax). The editorial device 110 may be yet further configured to receive a plurality of responses 116 (e.g., responsive to each query) from the question-answer system 104. More specifically, each response of the plurality of responses 116 may include an excerpt of text (e.g., a textual response) from a text (e.g., of the plurality of texts 112) read as input to the neural network 105, as described herein. For example, each response may include an excerpt of text (e.g., a textual response) from an indexed, highly relevant text. Similar examples may be found in a document entitled “End-to-End Open-Domain Question Answering with BERTserini” to Yang, Wei et al., the entire disclosure of which is hereby incorporated by reference herein. According to other aspects, each response of the plurality of responses 116 may include new text generated, by the question-answer system 104, based on the text (e.g., of the plurality of texts 112) read as input to the neural network 105. Based on each response of the plurality of responses 116, the editorial device 110 may be further configured to generate and to transmit a data structure 118 to the question-answer system 104 to build and/or update the knowledge base 120, as described herein.

According to various embodiments of the present disclosure, the editorial device 110 may include a plurality of interfaces 122 configured to transmit the plurality of queries 114 to and to receive the plurality of responses 116 from the question-answer system 104. According to various aspects, the data structure 118 may be generated based on control element inputs received via the plurality of interfaces 122.

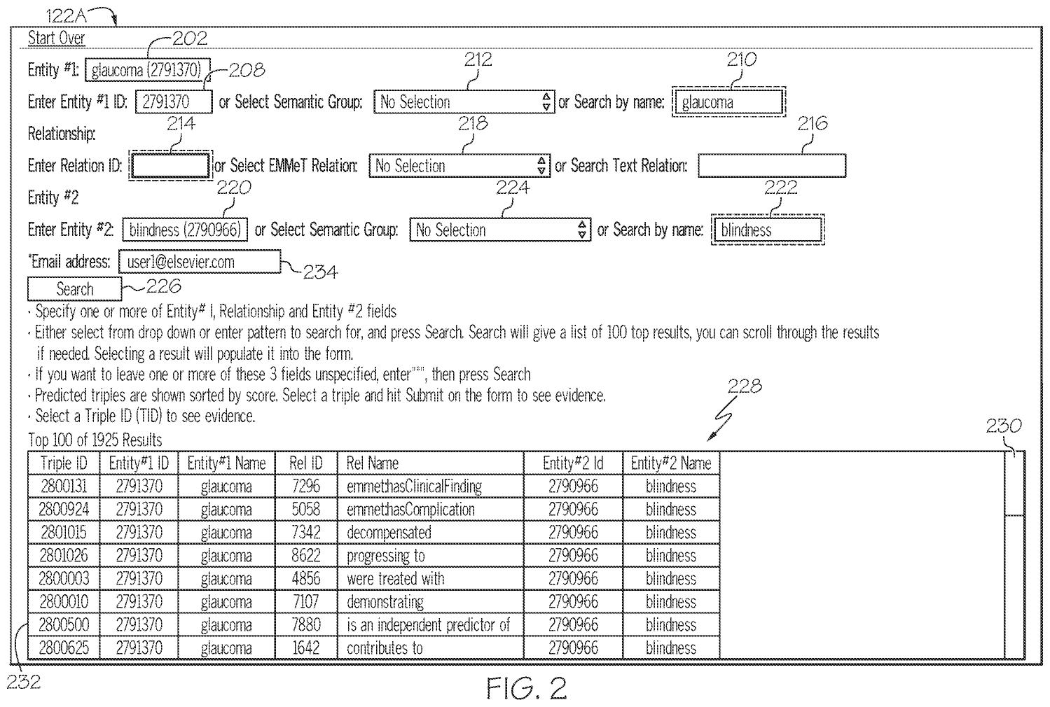

FIG. 2 depicts an illustrative interface 122A of the editorial device 110 according to one or more embodiments of the present disclosure. Referring to FIG. 2, the interface 122A may be configured to accept a query in the form of a triple (e.g., a Resource Description Framework triple). Each triple generally includes the following three parts: a Subject, a Predicate, and an Object (e.g., depicted herein using the notation: Subject—Predicate—Object). For example, a triple may include “diabetes—is a disorder of—endocrine system”. The subject “diabetes” denotes a resource, the object “endocrine system” denotes another resource and the predicate “is a disorder of” denotes a relationship between the subject and the object. Other example predicate forms may include, but are not limited to, “is a treatment for”, “is the cause of”, “is associated with”, “is an alternative remedy for”, and/or the like, and/or variants thereof. In the example of FIG. 2, the Subject is generically referenced as Entity #1 202, the Predicate is generically referenced as Relationship 204, and the Object is generically referenced as Entity #2 206. In this vein, Entity #1 202 is associated with a first entity #1 text box 208, a second entity #1 text box 210, and an entity #1 drop down menu 212. Similarly, Relationship 204 is associated with a first relationship text box 214, a second relationship text box 216, and a relationship drop down menu 218 and Entity #2 206 is associated with a first entity #2 text box 220, a second entity #2 text box 222, and an entity #2 drop down menu 224.

Referring to FIG. 2, according to various aspects of the present disclosure, a user (e.g., an editor, a reviewer, a subject matter or domain expert, a trained specialist, and/or the like) may search an Entity #1 202 (e.g., a Subject) of interest via a human-readable name by entering the human-readable name (e.g., “glaucoma”) in the second entity #1 text box 210. Similarly, the user may search a Relationship 204 (e.g., a Predicate) of interest via a human-readable name by entering the human-readable name in the second relationship text box 216 and the user may search an Entity #2 206 (e.g., an Object) of interest via a human-readable name by entering the human-readable name (e.g., “blindness”) in the second entity #2 text box 222. Here, according to various aspects, a Subject, Predicate, and/or Object of interest may be based on a triple (e.g., glaucoma—progressing to—blindness) that already exists in the knowledge base 120. In such aspects, the interface 122A of the editorial device 110 may be further configured to explore the knowledge base 120 (e.g., via communication link 115) for one or more existing triple to verify or expand.

Referring again to FIG. 2, according to aspects of the present disclosure, each part of each triple may be associated with a unique, machine-readable identifier (e.g., a subject identifier (SID), a predicate identifier (PID), an object identifier (OID)). In this vein, the user may search an Entity #1 202 of interest via a machine-readable identifier (e.g., if known to the user) by entering the machine-readable identifier (e.g., SID “2791370”) in the first entity #1 text box 208. Similarly, the user may search a Relationship 204 of interest via a machine-readable identifier (e.g., if known to the user) by entering the machine-readable identifier in the first relationship text box 214 and the user may search an Entity #2 206 of interest via a machine-readable identifier (e.g., if known to the user) by entering the machine-readable identifier (e.g., OID “2790966”) in the first entity #2 text box 220. According to various aspects the interface 122A may be configured to, after and/or during entry of the human-readable name (e.g., in the second entity #1 text box 210, the second relationship text box 216, and/or the second entity #2 text box 222) automatically populate its corresponding machine-readable identifier (e.g., in the first entity #1 text box 208, the first relationship text box 214, and/or the first entity #2 text box 220) and after and/or during entry of the machine-readable identifier (e.g., in the first entity #1 text box 208, the first relationship text box 214, and/or the first entity #2 text box 220) automatically populate its corresponding human-readable name (e.g., in the second entity #1 text box 210, the second relationship text box 216 and/or the second entity #2 text box 222). The interface 122A may be configured to automatically populate the human-readable name or the machine-readable identifier by transmitting (e.g., via communication link 115), in real-time or near real-time, the entered human-readable name or the entered machine-readable identifier to the question-answer system 104 and receiving (e.g., via the communication link 115), in real-time or near real-time, from the question-answer system 104 the corresponding machine-readable identifier or human-readable name. In such aspects, the question-answer system 104 may be configured to access a look-up table 133, as described more fully herein.

According to further aspects of the present disclosure, the user may enter a wildcard character in a text box of interface 122A if the user would like to leave the text box unspecified or undefined. In view of FIG. 2, for example, the user may search Relationship 204 by entering the wildcard character (e.g., “*”) in the first relationship text box 214. In some aspects, the interface 122A may be configured to accept the wildcard character in the first entity #1 text box 208, the first relationship text box 214, and/or the first entity #2 text box 220. In other aspects, the interface 122A may be configured to accept the wildcard character in the second entity #1 text box 210, the second relationship text box 216, and/or the second entity #2 text box 222. In yet further aspects, the interface 122A may be configured to accept the wildcard character in any of the first entity #1 text box 208, the second entity #1 text box 210, the first relationship text box 214, the second relationship text box 216, the first entity #2 text box 220, and/or the second entity #2 text box 222. According to other aspects, the interface 122A may be configured to similarly accept a blank text box, in addition to and/or in lieu of a wildcard character, as a way to leave the text box unspecified or undefined.

According to yet further aspects of the present disclosure, the interface 122A may be configured to receive a selection of a semantic group via the entity #1 drop down menu 212 and/or the entity #2 drop down menu 224. According to various aspects, the semantic group may restrict the results of a wild card search in the Entity #1 text box 208 to only those concepts in the knowledge base 120 which are members of that semantic group. For example, selecting the semantic group “diseases” would exclude any non-disease concepts from consideration. Similarly, the interface 122A may be configured to receive a selection of a knowledge base relation via the relationship drop down menu 218. In view of FIG. 2, continuing the example, Elsevier's Merged Medical Taxonomy (EMMeT) is a medical taxonomy knowledge base which could be loaded as knowledge base 120 for ongoing revisions. Accordingly, the relationship drop down menu 218 may be configured to present the user each relationship 204 (e.g., Predicate) currently defined in the knowledge base 120 (e.g., EMMeT) from which the user may select. Such an aspect may assist the user in selecting a relationship 204 appropriate for the knowledge base 120. Yet further, in view of FIG. 2, the interface 122A may be configured to accept user contact information (e.g., an e-mail address, and/or the like) via a user contact text box 234.

Referring still to FIG. 2, after selecting the search control element 226 (e.g., icon, button, and/or the like), the interface 122A may be configured to transmit the query 114 to the question-answer system 104 to probe the neural network 105 for textual evidence of the proposed triples corresponding to the query 114. Here, the neural network 105 may output a plurality of text fragments providing evidence for or against the queries 114 being triples that should be added to the knowledge base 120 in response to the reading of the plurality of texts 112 as input to the neural network 105. The question-answer system 104 may also query the knowledge base 120 to see if one or more of the plurality of proposed triples are already established as facts in the knowledge base. According to various aspects, the plurality of proposed triples may be stored in a proposed triples database 134 of the question-answer system 104 until evaluated by a user. In such aspects, after selecting the search control element 226, the interface 122A may be configured to present one or more than one proposed triple of the plurality of proposed triples (e.g., stored in the proposed triples database 134) in a list of proposed triples 228 in a portion (e.g., bottom portion) of the interface 122A. In light of FIG. 2, a list of proposed triples 228 for user evaluation may be relatively large (e.g., 1925 triples). The one or more than one proposed triple may be received as a response 116 to the query 114 where the one or more than one proposed triple corresponds to the query (e.g., fills-in the wildcard and/or blank of the query 114). Referring again to FIG. 2, the list of proposed triples 228 may include a predetermined number of triples out of a total number of triples (e.g., 100 triples of 1925 triples) and the user may utilize a scroll bar 230 to scroll through the predetermined number of triples. According to various aspects, the list of proposed triples 228 may be prioritized into a predetermined order, as described herein. Such prioritization may effectively separate legitimate and/or correct information responsive to the query 114 from possibly illegitimate and/or erroneous information (e.g., due to the nature of an automated system) responsive to the query 114. Such prioritization increases the efficiency of the user (e.g., editor, reviewer, subject matter or domain expert, trained specialist, and/or the like).

In one aspect, the list of proposed triples 228 may be ordered by date (e.g., associated with its underlying text source, when the triple was generated, and/or the like). Such a predetermined order (e.g., latest to earliest, earliest to latest, and/or the like) may permit the user to evaluate any change and/or shift in viewpoint over time (e.g., whether understood “facts” or “assertions” have changed over time).

In another aspect, the list of proposed triples 228 may be ordered based on origin of the underlying text sources. For example, a triple associated with a text source for which a copyright has been secured may be prioritized over a triple associated with a text source for which a copyright has not yet been secured.

In yet another aspect, the list of proposed triples 228 may be ordered based on evidentiary strength of the underlying text sources (e.g., considering an evidence pyramid, a pyramid of evidence-based medical sources, and/or the like). For example, a triple associated with a critically-appraised text source may be prioritized over a triple associated with an expert opinion text source.

In a further aspect, the list of proposed triples 228 may be ordered based on domain of the underlying text sources. For example, if a query pertains to the endocrine system, a triple associated with a text source limited to the domain of endocrinology may be prioritized over a triple associate with a text source not limited to the domain of endocrinology.

In a yet further aspect, the list of proposed triples 228 may be ordered based on predefined characteristics within the underlying text sources. Here, predefined characteristics may include one or more than one characteristic of interest (e.g., subjects, predicates, objects, complicating factors, and/or the like) defined by a user (e.g., editor, reviewer, subject matter or domain expert, trained specialist, and/or the like). For example, if “gluten sensitivity” “endocrine disorders”, and “Italian youth” are characteristics defined by the user, a triple associated with a text source pertaining such characteristics of interest (e.g., to endocrine disorders in Italian youth who also suffer from gluten sensitivity) may be prioritized over a triple associated with a text source not pertaining to such characteristics of interest. In this vein, according to various aspects, the one or more than one characteristic of interest defined by the user may be further used as a pre-filter to restrict the amount of texts 112 (e.g., to be searched with queries 114) as input to the neural network 105. In another aspect, continuing the ordering based on predefined characteristics aspect, the list of proposed triples 228 may be further ordered based on a relative frequency of a specific term or a term group within the underlying text sources. For example, if “endocrine disorders”, and “Italian youth” are characteristics defined by the user, a triple associated with a first text source pertaining to such characteristics of interest (e.g., to endocrine disorders in Italian youth) where the first text source contains a first specific term or first term group (e.g., “diabetes” as a disease) at a relatively higher frequency may be prioritized over a triple associated with a second text source pertaining to such characteristics of interest where the second text source contains a second specific term or second term group (e.g., “osteoporosis” as a disease) at a relatively lower frequency. Here, the first specific term or first term group (e.g., diabetes) may be a higher priority that the second specific term or second term group (e.g., osteoporosis) for the knowledge base 120 in the context of a youth cohort.

Referring still to FIG. 2, each triple in the list of proposed triples 228 may be associated with a corresponding unique, machine-readable triple identifier (TID) (e.g., TID 232). Continuing the example, while each triple in the list of proposed triples 228 is associated with SID “2791370”, which corresponds to “glaucoma” and OID “2790966”, which corresponds to “blindness” (e.g., as entered in the query 114), each respective triple may be associated with a different TID and a different PID. For example, TID 2801026 is associated with PID 8622, which corresponds to “progressing to”, TID 2800003 is associated with PID 4856, which corresponds to “were treated with”, TID 2800625 is associated with PID 1642, which corresponds to “contributes to”, and so forth. In such aspects, referring to FIG. 2, each TID (e.g., TID 232) in the list of proposed triples 228 may be configured as a hyperlink (e.g., an evidence hyperlink) for the user to select to view textual evidence that supports each respective triple in the list of proposed triples 228. According to such aspects, the list of proposed triples 228 provides a visual for the user (e.g., editor, reviewer, subject matter or domain expert, trained specialist, and/or the like) to evaluate the plurality of texts 112 read as input to the neural network 105. For example, a relatively large number of proposed triples may suggest that the plurality of texts 112 were relevant to the query 114 while a relatively small number of proposed triples may suggest that the plurality of texts 112 were not relevant to the query 114 and that further texts (e.g., corresponding to the query 114) may need to be read as input to the neural network 105. According to some aspects, the list of proposed triples 228 may include no proposed triple. In such an aspect, no proposed triple may suggest that further texts (e.g., corresponding to the query 114) may need to be read as input to the neural network 105 so that at least one triple and/or its corresponding supporting textual evidence can be identified. A focused search for such further texts may be processed via a text query 130 and text response 132 to the text source device 124, as described herein. Furthermore, given the interface 122A, the user may quickly determine (via inspection) whether one or more than one proposed triple needs further investigation (e.g., a proposed triple appears to be in error), the user may verify the one or more than one proposed triple, the user may determine whether the list of proposed triples 228 which corresponds to their query 114 needs expansion (e.g., more proposed triples corresponding to the query 114 are desired), and/or the like.

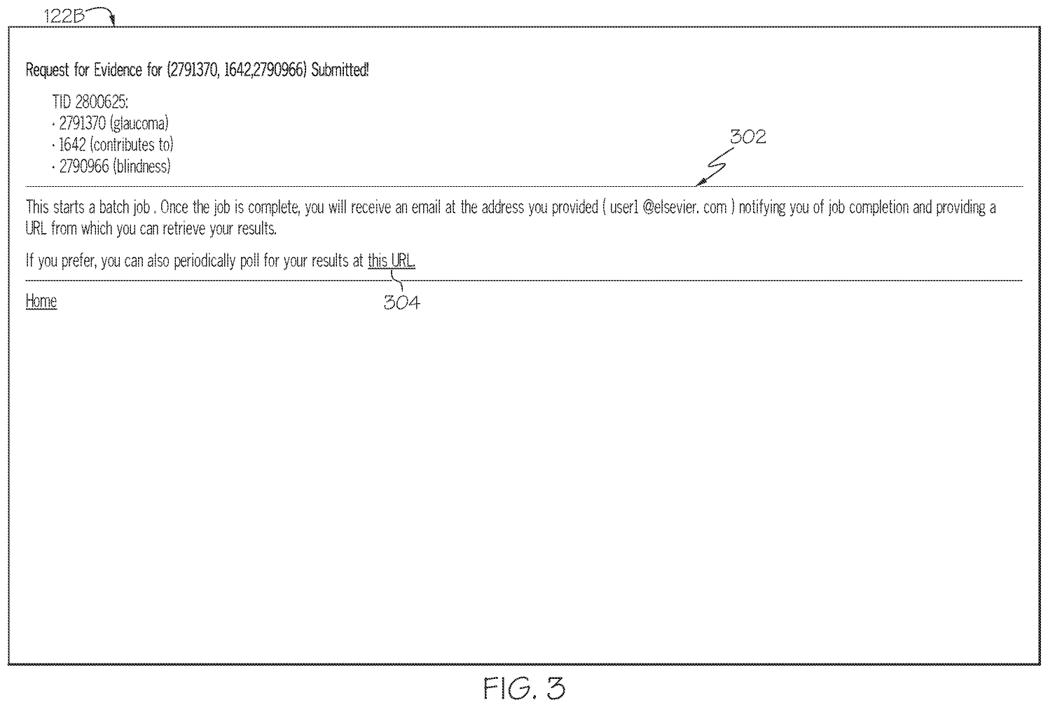

FIG. 3 depicts another illustrative interface 122B of the editorial device 110 according to one or more embodiments of the present disclosure. In particular, the editorial device 110 may present interface 122B after a user has selected a particular TID (e.g., via its respective hyperlink) from the list of proposed triples 228 (e.g., FIG. 2). According to various aspects, the interface 122B may confirm that a request for textual evidence associated with the particular TID (e.g., TID 2800625: 2791370 (glaucoma)—1642 (contributes to)—2790966 (blindness)) has been submitted. According to some aspects, the interface 122B may provide instructions 302 to the user that they will receive an e-mail including a uniform resource locator (URL) to indirectly access the textual evidence results associated with the selected TID. According to further aspects, the interface 122B may provide a URL 304 to directly access the textual evidence results associated with the selected TID.

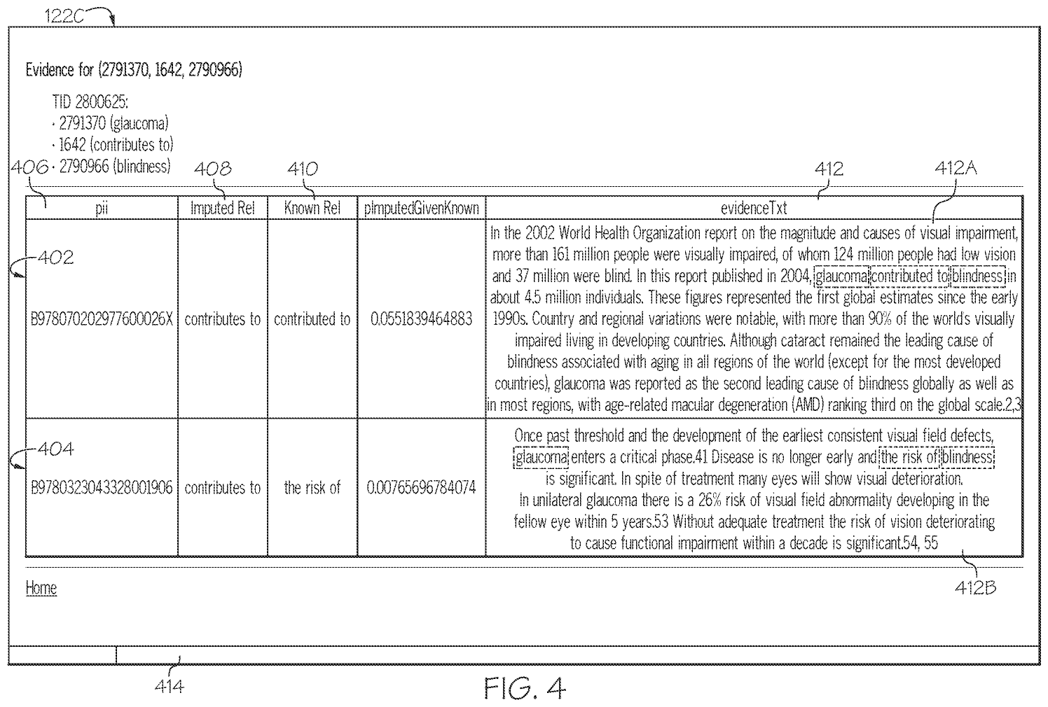

FIG. 4 depicts yet another illustrative interface 122C of the editorial device 110 according to one or more embodiments of the present disclosure. In particular, the editorial device 110 may present interface 122C after the user selects a URL provided via e-mail at an entered address (FIG. 1, e.g., via user contact text box 234) and/or after the user selects a URL provided via interface 122B (e.g., FIG. 3, URL 304). According to other aspects, the editorial device 110 may directly present interface 122C after the user has selected a particular TID (e.g., via its respective evidence hyperlink) from the list of proposed triples 228 (e.g., FIG. 2) without presenting interface 122B.

Referring to FIG. 4, continuing the example, the selected triple (e.g., TID 2800625: 2791370 (glaucoma)—1642 (contributes to)—2790966 (blindness)) is associated with a first textual evidence record 402 and a second textual evidence record 404. According to aspects of the present disclosure each textual evidence record may include a record identifier 406, an imputed relationship 408, a known relationship 410, and a span of text 412 (e.g., sentence W of paragraph X, paragraph Y of book Z, and/or the like). According to aspects described herein, each span of text 412 has been extracted from a text of the plurality of texts 112, read as input to the neural network 105. In view of FIG. 4, the interface 122C may be configured to visually distinguish each part of the selected triple within each span of text 412. For example, in the first span of text 412A associated with the first textual evidence record 402, the subject “glaucoma” is distinguished from surrounding text via a first dashed box in a first color (e.g., red), the predicate “contributed to” is distinguished from the surrounding text via a second dashed box in a second color (e.g., blue), and the object “blindness” is distinguished from the surrounding text via a third dashed box in a third color (e.g., green). Similarly, in the second span of text 412B associated with the second textual evidence record 404, the subject “glaucoma” is distinguished from surrounding text via a first dashed box in a first color (e.g., red), the neural network 105 has imputed that “the risk of,” in the context of the rest of the text, provides evidence for the predicate “contributes to.” Accordingly, “the risk of” is distinguished from the surrounding text via a second dashed box in a second color (e.g., blue), and the object “blindness” is distinguished from the surrounding text via a third dashed box in a third color (e.g., green). Other ways of distinguishing each part of the selected triple (e.g., highlighting) may be used. Accordingly, the interface 122C enables the user to quickly and efficiently locate respective components of each triple being evaluated. Furthermore, the interface 122C may enable the user to view each triple being evaluated in context of the text as input to the neural network 105 (e.g., sentence(s) including each part of the selected triple as well as the sentence before and after the sentence(s) including the selected triple, paragraph including each part of the selected triple as well as the paragraph before and after the paragraph including the selected triple, and/or the like). In view of FIG. 4, the knowledge base 120 has imputed a first textual variant (e.g., “contributed to”) of the first span of text 412A to the queried predicate (e.g., 1642 (contributes to)) and has imputed a second textual variant (e.g., “the risk of”) of the second span of text 412B to the queried predicate (e.g., 1642 (contributes to)).

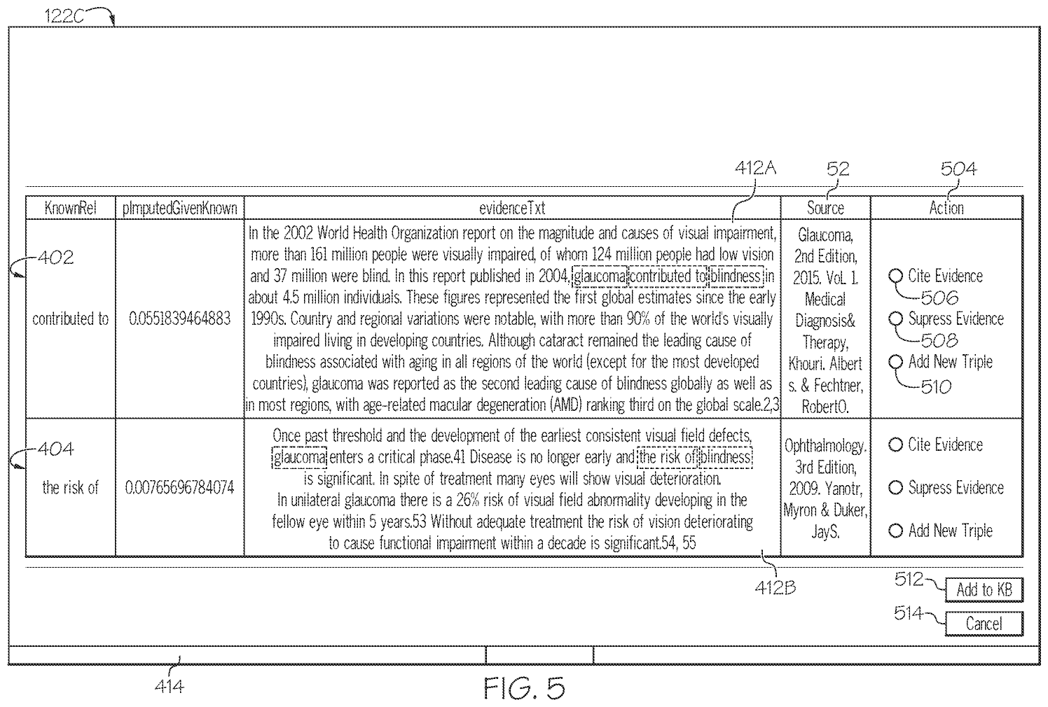

FIG. 5 depicts a scrolled view (e.g., via scroll bar 414) of the illustrative interface 122C of FIG. 4 according to one or more embodiments of the present disclosure. In view of FIG. 5, each of the first textual evidence record 402 and the second textual evidence record 404 may further include a source identifier 502 and a user action interface 504. In particular, the source identifier 502 may reference a source (e.g., book, guideline, clinical trial report, journal article, and/or the like) associated with its corresponding span of text (e.g., span of text 412A). Further, the user action interface 504 of the interface 122C may be configured to include one or more than one control element (e.g., check-box, button, and/or the like) to perform a designated action. As illustrated in FIG. 5, the user action interface 504 of each textual evidence record may be configured to include a “Cite Evidence” control element 506, a “Suppress Evidence” control element 508, and/or an “Add New Triple” control element 510. In such aspects, for example, if the user (e.g., editor, reviewer, subject matter or domain expert, trained specialist, and/or the like) determines that the first span of text 412A supports the selected triple (e.g., TID 2800625: 2791370 (glaucoma)—1642 (contributes to)—2790966 (blindness)) the user may select the “Cite Evidence” control element 506. Alternatively, if the user determines that the first span of text 412A is irrelevant to the selected triple, that all or a portion of the first span of text 412 is erroneous, that the first span of text 412 is duplicative, and/or the like, the user may select the “Suppress Evidence” control element 508. Furthermore, if the user determines that the first span of text 412A supports one or more additional triple, the user may select the “Add New Triple” control element 510. For example, in view of FIG. 4, the first span of text 412A further supports “cataract—leading cause of—blindness”, “glaucoma—leading cause of—blindness”, “age-related macular degeneration—leading cause of—blindness”, and/or the like. In such aspects, after selecting the “Add New Triple” control element 510, interface 122C may be configured to present an interface (e.g., similar to the upper portion of interface 122A, not shown) for the user to manually enter the one or more further supported triple.

According to various aspects, selecting the “Suppress Evidence” control element 508 may block that particular associated span of text (e.g., first span of text 412A) from being added to the knowledge base 120 to support the selected triple. In such an aspect, selecting the “Suppress Evidence” control element 508 may generate a span rejection record that associates that particular span of text with the selected triple. The span rejection record may be added to a span rejection portion of a data structure 118, where the span rejection portion of the data structure 118 is usable to block that particular associated span of text from being added to the knowledge base 120 to support the selected triple. According to other aspects, selecting the “Suppress Evidence” control element 508 may block all spans of text 412 associated with that source text (e.g., “Glaucoma, 2^{nd} Edition, 2015, Vol. 1, Medical Diagnosis & Therapy, Khouri, Albert S. & Fechtner, Robert D.) from being added to the knowledge base 120 to support the selected triple. In such an aspect, selecting the “Suppress Evidence” control element 508 may generate a source rejection record that associates the source text with the selected triple. The source rejection record may be added to a source rejection portion of a data structure 118, where the source rejection portion of the data structure 118 is usable to block any span of text associated with the source text from being added to the knowledge base 120 to support the selected triple. According to yet other aspects, selecting the “Suppress Evidence” control element 508 may generate a partially-completed record that associates that particular span of text (e.g., the first span of text 412A) with the selected triple. In such an aspect, the partially-completed record may be added to a data structure 118 to be transmitted to the question-answer system 104 for addition to the proposed triples database 134 (e.g., for subsequent evaluation via the editorial device 110). In some aspects, the partially-completed record may include a note from a user (e.g., the user that selected the “Suppress Evidence” control element 508) that describes one or more than one issue leading to the selection of the “Suppress Evidence” control element 508. According to various aspects, any record generated upon selection of the “Suppress Evidence” control element 508 (e.g., span rejection record, source rejection record, partially-completed record, and/or the like) may be transmitted to another user (e.g., another editor, another reviewer, another subject matter or domain expert, another trained specialist, and/or the like) and/or a supervisory user for re-evaluation (e.g., in a work flow).

Further in view of FIG. 5, the interface 122C may include an “Add to KB” control element 512 and a “Cancel” control element 514 (e.g., icon, button, and/or the like). In such aspects, the interface 122C may be configured to, after selection of the “Add to KB” control element 512, generate a record that associates the selected triple (e.g., TID 2800625: 2791370 (glaucoma)—1642 (contributes to)—2790966 (blindness)) with each textual evidence record (e.g., first textual evidence record 402, second textual evidence record 404, and/or the like) for which the “Cite Evidence” control element 506 has been selected. According to various aspects, the generated record may be added to a data structure 118 to be transmitted to the question-answer system 104 for addition to the knowledge base 120 (e.g., EMMeT medical taxonomy knowledge base, and/or the like). Each textual evidence record (e.g., span of text and associated source) for which the “Cite Evidence” control element 506 has been selected may then be tracked in the knowledge base 120 as the provenance for the triple being added.

The interface 122C may be further configured to, after selection of the “Add to KB” control element 512, generate a record that associates each added triple with its associated textual evidence record for which the “Add New Triple” control element 510 has been selected. According to various aspects, the generated record may be similarly added to the data structure 118 to be transmitted to the question-answer system 104 for addition to the knowledge base 120. In such aspects, each textual evidence record (e.g., span of text and associated source) for which the “Add New Triple” control element 510 has been selected may then be tracked in the knowledge base 120 as the provenance for the triple being added. According to another aspect, the generated record (e.g., that associates each added triple with its associated textual evidence record for which the “Add New Triple” control element 510 has been selected) may be added to the data structure 118 to be transmitted to the question-answer system 104 for addition to the proposed triples database 134 (e.g., for subsequent evaluation when a query pertaining to that triple is presented via the editorial device 110). In such aspects, the question-answer system 104 may be further configured to, after receiving the data structure 118, define a TID for each new triple and associate, via the look-up table 133, each defined TID with a SID, PID, and OID corresponding to each corresponding human-readable name. Further, in such aspects, if a part of a new triple (e.g., Subject, Predicate, or Object) is not yet defined in the look-up table 133, the question-answer system 104 may be further configured to define the unique, machine-readable identifier (e.g., SID, PID, OID, respectively) and store the defined machine-readable identifier in association with its human-readable name in the look-up table 133 (e.g., for future use). According to various aspects, after selection of the “Add to KB” control element 512, the editorial device 110 may be configured to again present interface 122A to the user (e.g., to select another proposed triple from the list of proposed triples 228 for evaluation).

Further in view of FIG. 5, the interface 122C may be configured to, after selection of the “Cancel” control element 514, exit the interface 122C and nullify any selected “Cite Evidence” and/or “Suppress Evidence” control elements (e.g., without making any changes). According to various aspects, after selection of the “Cancel” control element 514, the editorial device 110 may be configured to again present interface 122A to the user (e.g., to select another proposed triple from the list of proposed triples 228 for evaluation).

In light of FIGS. 1-5 as described herein, embodiments of the present disclosure enable a semi-automated editorial system and/or method that dynamically interacts with a user to assist the user in evaluating proposed triples for addition to the knowledge base 120. Accordingly, the interfaces 122 of the editorial device 110, as described herein, may be used to continually maintain and/or expand knowledge base 120 triples.

Referring briefly to FIG. 1, the knowledge base 120 of the neural network 105 may represent each relationship between its data as a triple (e.g., as a TID in association with a SID, a PID, and an OID). Such relationships may be represented and/or processed in machine-readable form. In such aspects, each machine-readable identifier (e.g., SID, PID, OID) may be associated with a human-readable name in a look-up table 133 of the question-answer system 104 (e.g., an SID corresponding to “glaucoma”, a PID corresponding to “contributes to”, and an OID corresponding to “blindness”). Accordingly, the question-answer system 104 may be configured to access the look-up table 133 to translate received queries (e.g., queries 114 from the editorial device 110, query 106 from the client device 102) and to translate transmitted responses (e.g., responses 116 to the editorial device 110, response 108 to the client device 102). Similarly, the question-answer system 104 may be configured to access the look-up table 133 to translate received data structures 118 prior to addition to the knowledge base 120 and/or proposed triples database 134, as described herein.

According to aspects described herein, each triple of the knowledge base 120 may be considered a “fact” or “assertion”. In some aspects, various triples may be combined into disjoint sets of triples, referred to herein as a graph (e.g., an H-graph), within the knowledge base 120. Each graph may also be associated with a unique, machine-readable graph identifier (GID). Accordingly, each GID may be associated with one or more TIDs in the look-up table 133 of the question-answer system 104.

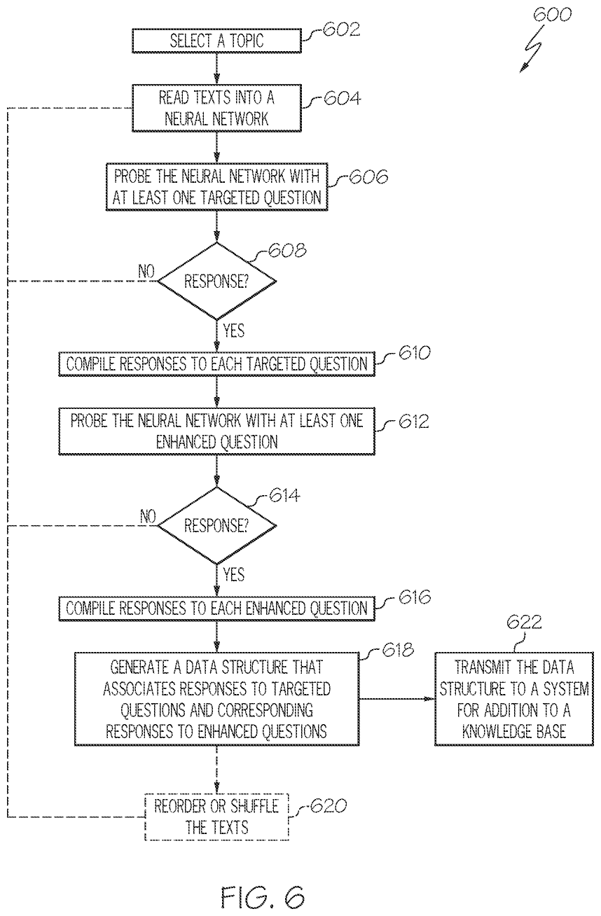

FIG. 6 depicts a flow diagram of an illustrative method 600 for the construction of a knowledge base 120 using a neural network 105, according to one or more embodiments of the present disclosure. At block 602, a topic (e.g., health related topic) may be selected. At block 604, texts (e.g., pre-selected or not pre-selected) associated with the selected topic may be read as input to a neural network 105 (e.g., via the text source device 124 and the editorial device 110 as described herein). According to various aspects, the texts associated with the selected topic may be read as input to the neural network 105 in a first order. At block 606, the neural network 105 may be probed with at least one targeted question (e.g., via interface 103 of client device 102 configured to accept queries 106, e.g., via a text box, in plain text or natural language without any particular query language). In some aspects, interface 122A may be similarly configured to include a text box to accept queries 114 (e.g., targeted questions) in plain text or natural language. In further aspects, the interface 122A may be configured to generate targeted questions. According to various aspects, a targeted question may be constructed to expand an assertion (e.g., new or existing) in the knowledge base 120. According to further aspects, a targeted question may be constructed to obtain confirmation or refutation of an assertion (e.g., new or existing) in the knowledge base 120. For example, a targeted question may be constructed based on an assertion (e.g., a triple) already existing in the knowledge base 120 in order to find evidence for that assertion in the texts. In one aspect, an assertion in the knowledge base 120 may be transformed into a true or false question. In another aspect, one or more part of an assertion in the knowledge base 120 may be redacted (e.g., the Subject, the Predicate, and/or the Object of a triple) and a question (e.g., fill-in-the-blank) may be constructed from the remaining part(s) of the assertion. Such redaction(s) may generate a large number of potential questions. For example, an existing knowledge base triple (e.g., diabetes—is a disorder of—the endocrine system) may be redacted to: (______—is a disorder of—the endocrine system). In this example, a constructed targeted question may be the natural language question: “What is a disorder of the endocrine system?”. Accordingly, such an aspect may be an alternative way to present a wildcard or blank query. According to various aspects described herein, the at least one targeted question may include a series of targeted questions. For example, an initial targeted question in a series of targeted questions may include “What is a treatment for coronary artery disease?” (obtained from the triple______—is a treatment for—coronary artery disease). Subsequent targeted questions in the series of targeted questions may include variations of the initial targeted question. For example, the subsequent targeted questions may include: “What is the first line of treatment for coronary artery disease?”, “What are recommended therapies for coronary artery disease?”, “Which intervention for coronary artery disease is recommended?”, and/or the like. According to various aspects, the subsequent targeted questions in the series of targeted questions may include variations of such questions using alternative names and/or synonyms (e.g., ischemic heart disease, atherosclerotic heart disease, atherosclerotic vascular disease, coronary heart disease, and/or the like, for coronary artery disease).

According to various aspects, alternate names or synonyms derived, received, or extracted from the knowledge base 120 may be used. Continuing the endocrine system example, a subsequent question to the targeted question “What is a disorder of the endocrine system?” may include “What is an illness of hormone regulation?”. In other aspects, part of an assertion (e.g., diabetes—is a disorder of—the endocrine system) in the knowledge base 120 may be substituted with a broader or more generalized term or a narrower or more specific term derived, received, or extracted from the knowledge base 120. For example, a subsequent question to the targeted question “What is a disorder of the endocrine system?” may include “What disease is a disorder of the endocrine system”. In yet further aspects, a combination of alternate names or synonyms and broader or more generalized terms or narrower or more specific terms may be used. For example, a subsequent question to the targeted question “What is a disorder of the endocrine system?” may include “What disease is an illness of hormone regulation?”. According to various aspects, at block 606, the neural network 105 may be probed with any particular targeted question, as described herein, more than one time. For example, the neural network 105 may be probed with a same targeted question, more than one time, to explore further responses associated with the selected topic, as described herein. Here, although the method described herein is explained with respect to endocrine system disorders and/or coronary artery disease, it should be understood that the method is similarly applicable to other diseases and/or other topics of inquiry.

At block 608, it may be determined whether a response (e.g., response 108 via interface 103 of client device 102) has been received for each targeted question. If one or more than one targeted question did not receive a response, the method 600 may return to block 604 (e.g., shown in phantom as optional) to read further, more focused texts (e.g., which correspond to the targeted question(s)) into the neural network 105. It is noted that if a targeted question did not receive a response, it is a possibility that there is no answer to the question. The method may suggest an additional decision point, such as “Try again for more texts?” or “Quit.” If each targeted question received at least one response, the method 600 may proceed to block 610.

At block 610, the responses from the question-answer system 104 to each targeted question may be compiled (e.g., via the interface 103 of the client device 102). Each response may include a triple and/or a span of text corresponding to the triple, as described herein. According to some aspects, a response to a targeted question (e.g., a targeted question constructed based on an assertion existing in the knowledge base 120) may confirm or refute an assertion existing in the knowledge base 120. For example, responses to “What is a disorder of the endocrine system?” may include triples and/or spans of text that indicate not only “diabetes” (e.g., confirming an existing knowledge base assertion) but also “Type 1 diabetes,” “Type 2 diabetes,” “osteoporosis”, “thyroid cancer”, “adrenal insufficiency,” “Adison's disease,” “Cushing's disease,” “Cushing's syndrome,” “Grave's disease,” “acromegaly,” “hyperthyroidism,” “hypothyroidism,” “Hashimoto's thyroiditis,” “hypopituitarism,” “multiple endocrine neoplasia I,” “multiple endocrine neoplasia II,” “polycystic ovary syndrome,” “precocious puberty,” and/or the like (e.g., suggesting new assertions to expand knowledge base 120 assertions). Accordingly, the compiled responses may represent possible and/or alternative knowledge base responses regarding endocrine system disorders. According to some aspects, where the question-answer system 104 has been probed with a same targeted question more than one time, subsequent responses may exclude previously provided responses for the user to explore further possible and/or alternative responses. For example, a first group of responses may be received in response to a first query using a targeted question, a second group of responses (e.g., excluding the first group of responses) may be received in response to a second query using the same targeted question, a third group of responses (e.g., excluding the first group of responses and the second group of responses) may be received in response to a third query using the same targeted question, and so forth. According to other aspects, where the question-answer system 104 has been probed with a same targeted question more than one time, subsequent responses may, rather than excluding previously provided responses from subsequent responses, provide previously provided responses at the end of a response list for the user to sequentially explore further possible and/or alternative responses prior to the previously provided responses. For example, a first group of responses may be received in response to a first query using a targeted question, a second group of responses (e.g., with the first group of responses appended to the end of the second group of responses) may be received in response to a second query using the same targeted question, a third group of responses (e.g., with the first group of responses and the second group of responses appended to the end of the third group of responses) may be received in response to a third query using the same targeted question, and so forth. Here, re-evaluation of a previously provided response may confirm that no further possible and/or alternative response to that same targeted question exists from the text(s) read into the question-answer system 104.

According to various aspects, at block 608, the series of targeted questions may enable a measure of confidence (e.g., correctness) with respect to a particular response of the compiled responses (e.g., response consistency). Confidence may be based on a source associated with the particular response (e.g., strength of that source in an evidence pyramid). In one example, confidence may be based on the source of that particular response—e.g., the strength of that source in an evidence pyramid where systematic reviews are considered as higher quality evidence than textbooks. In a further example, confidence may be based on a frequency at which the same or similar response occurs given the variations of the question and/or the submission of a same question, as described herein. In yet a further example, confidence may be based on a number of users (e.g., editors, reviewers, subject matter or domain experts, trained specialists, and/or the like) that agree with a response (i.e., the editorial device provides a voting mechanism to assess the agreement of multiple users). Accordingly, the methods and systems of the present disclosure may augment its users to ensure a supervised and/or controlled construction of the knowledge base 120.

At block 612, the question-answer system 104 may be probed with at least one enhanced question (e.g., via the interface 103 of the client device 102 configured to accept queries in plain text). In some aspects, interface 122A may be similarly configured to include a text box to accept queries 114 (e.g., enhanced questions) in plain text or natural language. In further aspects, the interface 122A may be configured to generate enhanced questions. In some aspects, Enhanced questions recognize that assertions (e.g., triples) may not be absolute. Continuing the coronary artery disease example, a first assertion (e.g., lifestyle changes and drug therapy—is a treatment for—coronary artery disease), a second assertion (e.g., percutaneous transluminal coronary angioplasty—is a treatment for—coronary artery disease), and a third assertion (e.g., coronary artery bypass surgery—is a treatment for—coronary artery disease) may all be user verifiable treatments for coronary artery disease. However, one treatment (e.g., lifestyle change and drug therapy) may be a preferred (e.g., due to established care guidelines amongst healthcare providers) over another treatment(s) (e.g., percutaneous transluminal coronary angioplasty and/or coronary artery bypass surgery). Going a step further, one treatment may be preferred over another treatment(s) for one cohort (e.g., one group of people having a particular characteristic) but not for another cohort (e.g., another group of people having another particular characteristic). Furthermore one treatment may be available (e.g., due to regulatory approval by a country) while another treatment(s) may not be available (e.g., due to regulatory disapproval by a country). In this vein, each enhanced question may be constructed using an enhanced question template. One example enhanced question template may take a particular response to a targeted question (e.g., block 608) and insert one or more than one part of the particular response into a new question to focus on (e.g., further inquire regarding) one or more than one aspect of the particular response. For example, if a response to the targeted question “What is a treatment for coronary artery disease?” is the following triple: percutaneous transluminal coronary angioplasty—is a treatment for—coronary artery disease, an enhanced question including “When should percutaneous transluminal coronary angioplasty not be used as a treatment for coronary artery disease?” may be constructed using the example enhanced question template. In a similar way, each enhanced question may focus on a characteristic associated with a particular response. In some aspects of the present disclosure, the characteristic may include demographic considerations (e.g., age, gender, ethnicity, and/or the like), complicating conditions (e.g., pregnancy, diabetes, heart disease, and/or the like), other treatments (e.g., high-blood pressure medications, and/or the like), and/or the like. According to further aspects, the at least one enhanced question may include a series of enhanced questions. For example, the series of enhanced questions may include: “What is a second line of treatment for coronary artery disease?”, “What are considerations in treating coronary artery disease in a pregnant person?”, “Is coronary artery bypass surgery for coronary artery disease contraindicated for a person with diabetes?” (e.g., an enhanced question template having the form: Is treatment for disease contraindicated for cohort?), “Is a person taking high-blood pressure medication at risk for complications of coronary artery disease?” (e.g., another enhanced question template having the form: Is cohort at risk for complications of disease?), “What complications of coronary artery disease are possible for a person over 50 years old?” (e.g., yet another enhanced question template having the form: What complications of disease are possible for cohort?), and/or the like. Accordingly, a series of enhanced questions may reveal further information corresponding to a particular assertion (e.g., preference for a treatment of the assertion relative to other treatments given care guidelines amongst healthcare providers, preference for the treatment of the assertion relative to other treatments given a cohort characteristic, availability of the treatment of the assertion given regulatory concerns, and/or the like). According to various aspects, at block 612, the question-answer system 104 may be probed with any particular enhanced question, as described herein, more than one time. For example, the question-answer system 104 may be probed with a same enhanced question, more than one time, to explore further responses associated with the selected topic.

At block 614, it may be determined whether a response (e.g., response 108 via interface 103 of client device 102) has been received for each enhanced question. If one or more than one enhanced question did not receive a response, the method 600 may return to block 604 (e.g., shown in phantom as optional) to read further, more focused texts (e.g., which correspond to the enhanced question(s)) into the question-answer system 104. It is noted that the method 600 may terminate in some instances where there is no response, such as in cases where no answer exists. If one or more enhanced questions received at least one response, the method 600 may proceed to block 616. At block 616, the responses from the question-answer system 104 to each enhanced question may be compiled (e.g., via the interface 103 of the client device 102). According to some aspects, where the question-answer system 104 has been probed with a same enhanced question more than one time, subsequent responses may exclude previously provided responses for the user to explore further possible and/or alternative responses, as described herein. According to other aspects, where the question-answer system 104 has been probed with a same enhanced question more than one time, subsequent responses may, rather than excluding previously provided responses from subsequent responses, provide previously provided responses at the end of a response list for the user to sequentially explore further possible and/or alternative responses prior to the previously provided responses, as described herein. Here, re-evaluation of a previously provided response may confirm that no further possible and/or alternative response to that same enhanced question exists from the text(s) read into the neural network 105.

At block 618, a data structure 107 may be generated to build and/or update the knowledge base 120. In particular, the data structure 107 may associate responses to the targeted questions and corresponding responses to enhanced questions. For example, the data structure 107 may link a triple derived from a particular targeted question to one or more than one triple derived from one or more enhanced question corresponding to the particular targeted question. In one aspect, pointers may be used to link the various triples within the data structure 107. According to aspects of the present disclosure, due to the targeted questions and enhanced questions, the generated data structure 107 goes beyond a conventional triple to reveal more useful, more detailed information on a topic.

In some aspects, an order (e.g., the first order) in which the texts associated with the selected topic have been read into the neural network 105 (e.g., at block 604) may affect the responses returned. Accordingly, at block 620 (e.g., shown in phantom as an optional step), the texts (e.g., pre-selected or not pre-selected) associated with the selected topic may be reordered and/or shuffled (e.g., into a second order, a third order, and/or the like, different than the first order) and the method of blocks 604 through 618 repeated. According to various aspects (e.g., if the optional step of block 620 has been performed), a response associated with a highest confidence may be selected for inclusion in the data structure 107. Such an approach may enable the neural network 105 to avoid giving a different response based on the order in which the texts have been read as input to the neural network 105. Accordingly, including block 620 in the method 600 may increase the measure of confidence with respect to the responses. According to various aspects, block 620 may be performed a pre-determined number of times.

At block 622, the generated data structure 107 may be transmitted to a system (e.g., question-answer system 104) for addition to a knowledge base 120. According to aspects of the present disclosure, each targeted question response and each corresponding enhanced question response may be further vetted (e.g., via interface 122C and/or the like) by a user and cited (e.g., accepted) or suppressed (e.g., rejected) as described herein. According to various aspects, the generated data structure 107 may add and/or modify particular assertions within a knowledge graph of the knowledge base 120 to include linked assertions that account for further factors (e.g., preferences, cohorts, regulations, and/or the like) associated with the particular assertions.

According to various embodiments of the present disclosure, the method 600 may be repeated with a related topic (e.g., another health-related topic) to build a knowledge base 120 pertaining to associated topics (e.g., a health-related knowledge base). Furthermore, although the method of FIG. 6 references the client device 102, it should be understood that such steps, as described herein, could be similarly performed by the editorial device 110. Stated differently, the client device 102 and the editorial device 110, and the respective functionalities associated therewith, may be combined into a single device.

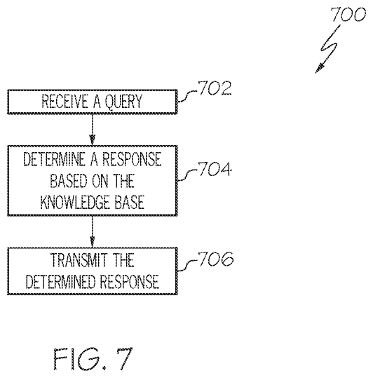

FIG. 7 depicts a flow diagram of an illustrative method 700 for using the knowledge base 120 (e.g., constructed and/or maintained using the neural network 105 as described herein), according to one or more embodiments of the present disclosure. At block 702, the question-answer system 104 may receive a query 106. According to various aspects, the question-answer system 104 may receive the query 106 from a client device 102.

In some aspects, the client device 102 (e.g., as depicted in FIG. 1) may be associated with a service recipient (e.g., searcher and/or the like) unrelated to the editorial device 110 and/or the text source device 124, as described herein. For example, at least one of the editorial device 110 or the text source device 124 may be associated with a service provider that provides search-related services to the service recipient via the client device 102. According to various aspects, such search-related services may be subscription based. Accordingly, prior to submitting the query 106, the service recipient and/or the client device 102 may be authenticated via an authentication procedure. Furthermore in such aspects, the client device 102 (e.g., associated with the service recipient) may not be configured to generate a data structure 107 and/or to transmit the data structure 107 to the question-answer system 104 for addition to the knowledge base 120 as described herein. In some aspects, the client device 102 (e.g., associated with the service recipient) may be configured to send queries 106 and receive responses 108 as described herein.

According to other aspects, the client device 102 may be associated with a user (e.g., an editor, a subject matter or domain expert, a trained specialist, and/or the like) related to the question-answer system 104, the editorial device 110, and/or the text source device 124. For example, the client device 102 (e.g., associated with the user) may be used to test responses 108 to queries 106 as well as to build the knowledge base 120 (e.g., FIG. 6). In such aspects, although the method of FIG. 7, as described herein, references the client device 102, it should be understood that such steps could be performed by the editorial device 110 in addition to and/or in lieu of the client device 102 (e.g., associated with the user).

Referring again to FIG. 7, at block 704, the neural network 105 may determine a response 108 to the query based on its knowledge base 120. According to various aspects, the question-answer system 104 may access data structures stored in the knowledge base 120 (e.g., via the method 600 of FIG. 6) to determine a response 108 to the query 106. As another example, the question-answer system 104 may call on the neural network 105 and the look-up table 133 for information that is needed to determine a response 108 to the query 106. According to some aspects, a data structure may be navigated to determine a more detailed response to a more detailed query. At block 706, the neural network 105 may transmit the determined response 108 to the client device 102. In some aspects, the response 108 may include an excerpt of text (e.g., textual response) from an original text read into the neural network 105 (e.g., FIG. 6, block 604). According to other aspects, the response 108 may include new text generated based on the original text read into the neural network 105 through the facility of natural language questions submitted to a question-answer system 104.

Although the systems, devices, and methods described herein are explained within the medical context, the systems, devices, and methods described herein are not limited to that domain. Namely, it should be understood that the systems, devices, and methods described herein may similarly apply to any domain (e.g., agriculture, astronomy, chemistry, humanities, psychology, sociology, zoology, and/or the like).

It should now be understood that the systems, devices and methods described herein are suitable for constructing and/or maintaining a knowledge base 120 using an editorial device 110. More specifically, the systems, devices and methods described herein provide not only a more efficient front end system (e.g., for generating selective texts for input to the neural network 105) but also a back end system (e.g., editorial device 110 and interfaces 122 described herein) for curating neural network 105 outputs to construct and/or maintain a knowledge base 120 associated with the neural network 105.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system to maintain a knowledge base, the system comprising:
a device including a processor and a memory, the memory storing program instructions that, when executed by the processor, cause the device to:
generate a first interface, wherein the first interface is configured to:
receive a query for transmission to a question-answer system; and
provide a response to the query from the question-answer system, wherein the response includes one or more than one proposed triple in a list of proposed triples;
after selection of a particular triple in the list of proposed triples, generate a second interface, wherein the second interface is configured to:
provide at least one evidence record associated with the particular triple, wherein each evidence record includes a span of text in support of the particular triple; and
provide one or more than one control element in association with each evidence record, wherein the one or more than one control element includes at least one of:
a first control element selectable to cite its corresponding evidence record and span of text as supporting the particular triple; or
a second control element selectable to prevent its corresponding evidence record and span of text from being cited as supporting the particular triple; and
generate a data structure, based on selections of the one or more than one control element, to update the knowledge base.

2. The system of claim 1, wherein the system includes more than one of the device.

3. The system of claim 1, wherein the first interface is configured to receive the query as a triple having a first part, a second part, and a third part.

4. The system of claim 3, wherein the first interface is configured to receive the triple with one or more than one of the first part, the second part, and the third part undefined.

5. The system of claim 3, wherein the first interface is configured to receive at least one of the first part, the second part, or the third part in human-readable form or machine-readable form, and wherein the first interface is further configured to, after or during receipt of the at least one of the first part, the second part, or the third part in machine-readable form, automatically populate its corresponding human-readable form in the first interface.

6. The system of claim 1, wherein each proposed triple in the list of proposed triples is associated with a respective evidence hyperlink, and wherein each respective evidence hyperlink is selectable to generate the second interface.

7. The system of claim 1, wherein the first interface is configured to provide the list of proposed triples in a predetermined order.

8. The system of claim 7, wherein the predetermined order is based on at least one of text source date, text source origin, text source evidentiary strength, text source domain, or text source characteristics of interest.

9. The system of claim 1, wherein the second interface is further configured to visually distinguish components of the particular triple within each span of text corresponding to each evidence record.

10. The system of claim 1, wherein the one or more than one control element includes at least one of the first control element, the second control element, or a third control element selectable to add a triple supported by the corresponding evidence record and span of text.

11. The system of claim 1, wherein the program instructions, when executed by the processor, further cause the device to:
receive a text query for transmission to a text source device, wherein the text query pertains to a particular topic; and
transmit a plurality of texts, pertaining to the particular topic, to the question-answer system for input to a neural network of the question-answer system, the plurality of texts received as a text response to the text query.

12. The system of claim 11, wherein the text source device comprises a database storing a body of text, and a full-text search engine configured to identify the plurality of texts from the body of texts.

13. The system of claim 1, wherein the first interface is configured to receive the query in the form of a question in natural language, the received query targeted on a particular topic.

14. The system of claim 13, wherein the first interface is further configured to generate one or more than one targeted question based on at least one of:
a particular triple stored in the knowledge base, the one or more than one targeted question including at least one of:
a true or false question derived from one or more than one of the first part, the second part, and the third part of the particular triple; or
a fill-in-the-blank question derived by:
redacting at least one of the first part, the second part, or the third part of the particular triple; and
forming the fill-in-the-blank question from the at least one of the first part, the second part, or the third part of the particular triple that remains; or
the received query, the one or more than one targeted question including at least one of:
a question that substitutes an alternative name or a synonym for a term in the received query; or
a question that broadens or narrows the scope of a term in the received query.

15. The system of claim 14, wherein the first interface is further configured to generate one or more than one enhanced question based on at least one of:
a particular proposed triple provided in response to the one or more than one targeted question, the one or more enhanced question including:
a focusing question derived by:
extracting at least one of the first part, the second part, or the third part of the particular proposed triple; and
forming the focusing question from the at least one of the first part, the second part, or the third part extracted to further inquire regarding the at least one of the first part, the second part, or the third part extracted.

16. The system of claim 15, wherein the further inquiry regarding the at least one of the first part, the second part, or the third part extracted focuses on at least one of a guidelines consideration, a cohort consideration, or a regulatory consideration.

17. A system to maintain a knowledge base, the system comprising:
a question-answer system including a processor and a memory, the memory storing:
a neural network;
a knowledge base;
a proposed triples database; and
program instructions that, when executed by the processor, cause the question-answer system to:
read a plurality of texts received from a device as input to the neural network;
receive, as input into the neural network, one or more natural language questions;
generate, using the neural network, neural network outputs comprising one or more text fragments, wherein the one or more text fragments are evidence of proposed triples;
store the neural network outputs, corresponding to the plurality of texts, as the proposed triples in the proposed triples database;
respond to queries received from the device based on the proposed triples stored in the proposed triples database; and
update the knowledge base based on one or more than one data structure received from the device.

18. The system of claim 17, wherein the memory further stores a look-up table, and wherein the program instructions, when executed by the processor, further cause the question-answer system to:
receive, in human-readable form, at least one of a first part, a second part, or a third part of a triple from the device;
access the look-up table to translate the at least one of the first part, the second part, or the third part into machine-readable form; and
transmit the at least one of the first part, the second part, or the third part translated into machine-readable form to the device.

19. A method to maintain a knowledge base, the method comprising:
entering, via a first interface of a device, a query for transmission to a question-answer system;
receiving, via the first interface, a response to the query from the question-answer system, wherein the response includes one or more than one proposed triple in a list of proposed triples;
receiving, via a second interface of the device, at least one evidence record associated with a particular triple selected from the list of proposed triples, wherein each evidence record includes a span of text in support of the particular triple;
selecting, via the second interface, a control element associated with each evidence record, wherein the control element includes one of:
a first control element to cite the corresponding evidence record and span of text as supporting the particular triple; or
a second control element to prevent the corresponding evidence record and span of text from being cited as supporting the particular triple; and
generating a data structure, based on the selected control element, to update the knowledge base.

20. The method of claim 19, wherein entering the query includes entering a triple including one or more than one of a first part, a second part, and a third part, and wherein receiving the response includes receiving the list of proposed triples in a predetermined order based on at least one of text source date, text source origin, text source evidentiary strength, text source domain, or text source characteristics of interest.
